(19) United States
(12) Patent Application Publication
(10) Pub. No.: US 2018/0358004 A1
(43) Pub. Date: Dec. 13, 2018

(54) APPARATUS, METHOD, AND PROGRAM PRODUCT FOR SPELLING WORDS

(71) Applicant: LENOVO (Singapore) PTE. LTD., New Tech Park (SG)

(72) Inventors: John Weldon Nicholson, Cary, NC (US); Daryl Cromer, Cary, NC (US); David Alexander Schwarz, Morrisville, NC (US)

(21) Appl. No.: 15/616,441

(22) Filed: Jun. 7, 2017

(51) Int. Cl. G10L 15/187; G10L 15/22; G06F 3/16

(52) U.S. Cl. CPC G10L 15/187; G06F 3/167; G10L 15/22

(57) ABSTRACT

Apparatuses, methods, and program products are disclosed for spelling words. One apparatus includes a sensor, a processor, and a memory that stores code executable by the processor. The code is executable by the processor to detect, by use of the sensor, an audio input. The audio input includes instructions for spelling a word. The code is executable by the processor to convert the audio input to text. The text includes the word. The code is executable by the processor to spell the word based on a context of the instructions within the text. The instructions include natural language terminology.

### FIELD

The subject matter disclosed herein relates to spelling words and more particularly relates to spelling words based on instructions.

### BACKGROUND

### Description of the Related Art

Information handling devices, such as desktop computers, laptop computers, tablet computers, smart phones, optical head-mounted display units, smart watches, televisions, streaming devices, etc., are ubiquitous in society. These information handling devices may be used for performing various actions. Performing various actions, such as converting speech to text, may be performed incorrectly.

### BRIEF SUMMARY

An apparatus for spelling words is disclosed. A method and computer program product also perform the functions of the apparatus. In one embodiment, the apparatus includes a sensor, a processor, and a memory that stores code executable by the processor. The code, in various embodiments, is executable by the processor to detect, by use of the sensor, an audio input. In such embodiments, the audio input includes instructions for spelling a word. The code, in some embodiments, is executable by the processor to convert the audio input to text. In such embodiments, the text includes the word. The code, in certain embodiments, is executable by the processor to spell the word based on a context of the instructions within the text. In such embodiments, the instructions include natural language terminology.

In some embodiments, the code executable by the processor spells the word based on the context of a direct spelling of the word within the text. In one embodiment, the code executable by the processor spells the word based on the context of a partial spelling of the word within the text.

In another embodiment, the code executable by the processor spells the word based on the context of a change to one or more letters of the word within the text. In some embodiments, the code executable by the processor spells the word based on the context of a spelling of at least one letter of the word using a phonetic alphabet within the text.

A method for spelling words, in one embodiment, includes detecting, by use of a sensor, an audio input. In some embodiments, the audio input includes instructions for spelling a word. In a further embodiment, the method includes converting the audio input to text. In various embodiments, the text includes the word. In some embodiments, the method includes spelling the word based on a context of the instructions within the text. In such embodiments, the instructions include natural language terminology.

In some embodiments, spelling the word based on the context of the instructions within the text includes spelling the word based on the context of a direct spelling of the word within the text. In various embodiments, spelling the word based on the context of the instructions within the text includes spelling the word based on the context of a partial spelling of the word within the text. In one embodiment, spelling the word based on the context of the instructions within the text includes spelling the word based on the context of a change to one or more letters of the word within the text.

In some embodiments, spelling the word based on the context of the instructions within the text includes spelling the word based on the context of a spelling of at least one letter of the word using a phonetic alphabet within the text. In certain embodiments, spelling the word based on the context of the instructions within the text includes spelling the word based on the context of speech that a person uses when speaking to another person within the text. In various embodiments, the method includes displaying the word in response to spelling the word based on the context of the instructions within the text. In certain embodiments, the method includes determining that the audio input includes the instructions for spelling the word. In some embodiments, the method includes not displaying the instructions in response to determining that the audio input includes the instructions.

In one embodiment, a program product includes a computer readable storage medium that stores code executable by a processor. The executable code, in certain embodiments, includes code to perform detecting, by use of a sensor, an audio input. In various embodiments, the audio input includes instructions for spelling a word. The executable code, in some embodiments, includes converting the audio input to text. In such embodiments, the text includes the word. The executable code, in certain embodiments, includes spelling the word based on a context of the instructions within the text. In one embodiment, the instructions include natural language terminology.

In certain embodiments, the executable code includes code to perform spelling the word based on the context of speech that a person uses when speaking to another person within the text. In some embodiments, the executable code includes code to perform spelling the word based on the context of a change to one or more letters of the word within the text. In various embodiments, the executable code includes code to perform displaying the word in response to spelling the word based on the context of the instructions within the text.

In one embodiment, the executable code includes code to perform determining that the audio input includes the instructions for spelling the word. In certain embodiments, the executable code includes code to perform not displaying the instructions in response to determining that the audio input includes the instructions.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for spelling words;

FIG. 2 is a schematic block diagram illustrating one embodiment of an apparatus including an information handling device;

FIG. 3 is a schematic block diagram illustrating one embodiment of an apparatus including a speech-to-text module;

FIG. 4 is a schematic block diagram illustrating another embodiment of an apparatus including a speech-to-text module;

FIG. 5 is a schematic flow chart diagram illustrating an embodiment of a method for spelling words; and

FIG. 6 is a schematic flow chart diagram illustrating another embodiment of a method for spelling words.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

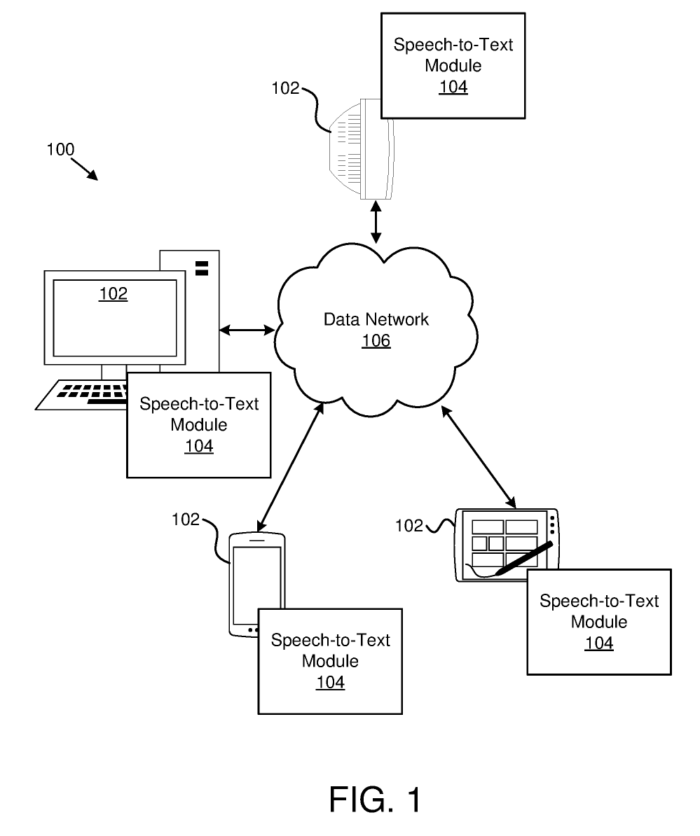

FIG. 1 depicts one embodiment of a system 100 for spelling words. In one embodiment, the system 100 includes information handling devices 102, control modules 104, and data networks 106. Even though a specific number of information handling devices 102, speech-to-text modules 104, and data networks 106 are depicted in FIG. 1, one of skill in the art will recognize that any number of information handling devices 102, speech-to-text modules 104, and data networks 106 may be included in the system 100.

In one embodiment, the information handling devices 102 include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), streaming devices, or the like. In some embodiments, the information handling devices 102 include wearable devices, such as smart watches, fitness bands, optical head-mounted displays, or the like. The information handling devices 102 may access the data network 106 directly using a network connection.

The information handling devices 102 may include an embodiment of the speech-to-text module 104. In certain embodiments, the speech-to-text module 104 may detect, by use of a sensor, an audio input. In some embodiments, the audio input includes instructions for spelling a word. The speech-to-text module 104 may also convert the audio input to text. In certain embodiments, the text includes the word. The speech-to-text module 104 may spell the word based on a context of the instructions within the text. In various embodiments, the instructions include natural language terminology. In this manner, the speech-to-text module 104 may be used for spelling words.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a WAN, a storage area network (“SAN”), a LAN, an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

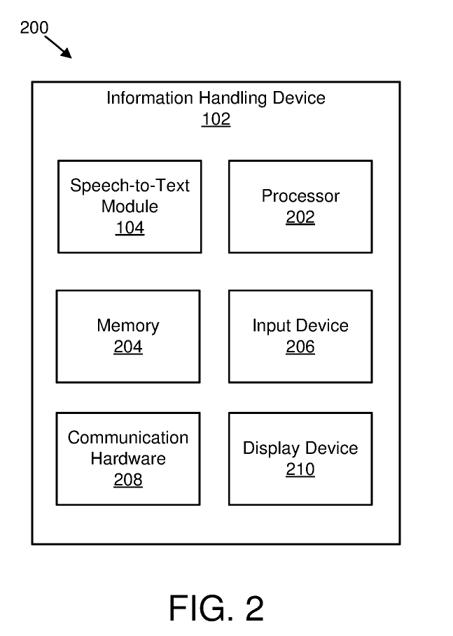

FIG. 2 depicts one embodiment of an apparatus 200 that may be used for spelling words. The apparatus 200 includes one embodiment of the information handling device 102. Furthermore, the information handling device 102 may include the speech-to-text module 104, a processor 202, a memory 204, an input device 206, communication hardware 208, and a display device 210. In some embodiments, the input device 206 and the display device 210 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the speech-to-text module 104, the input device 206, the communication hardware 208, and the display device 210.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores data relating to performing an action in response to a movement. In some embodiments, the memory 204 also stores program code and related data, such as an operating system or other controller algorithms operating on the information handling device 102.

The information handling device 102 may use the speech-to-text module 104 for spelling words. As may be appreciated, the speech-to-text module 104 may include computer hardware, computer software, or a combination of both computer hardware and computer software. For example, the speech-to-text module 104 may include circuitry, or a processor, used to detect, by user of a sensor (e.g., the input device 206), an audio input. As another example, the speech-to-text module 104 may include computer program code used to convert the audio input to text. As a further example, the speech-to-text module 104 may include computer program code used to spell the word based on a context of the instructions within the text.

The input device 206, in one embodiment, may include any known computer input device including a touch panel, a button, a keyboard, a stylus, a microphone, an audio input device, or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, a streaming device, or the like.

In certain embodiments, the display device 210 includes one or more speakers for producing sound. For example, the display device 210 may produce an audible alert or notification (e.g., a beep or chime). In some embodiments, the display device 210 includes one or more haptic devices for producing vibrations, motion, or other haptic feedback. For example, the display device 210 may produce haptic feedback upon performing an action.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202 and/or the speech-to-text module 104.

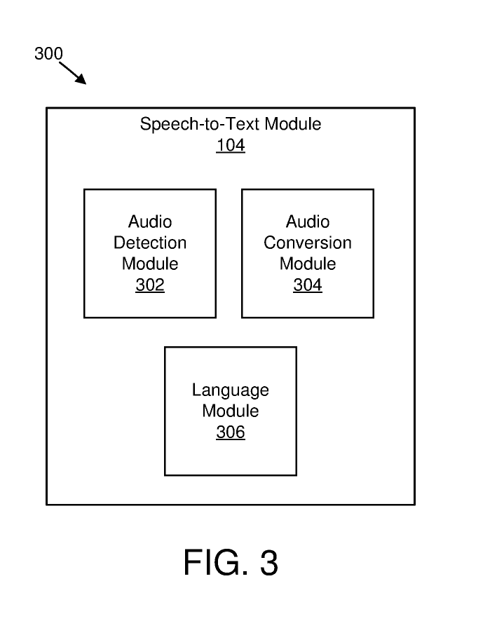

FIG. 3 depicts a schematic block diagram illustrating one embodiment of an apparatus 300 that includes one embodiment of the speech-to-text module 104. Furthermore, the speech-to-text module 104 includes an audio detection module 302, an audio conversion module 304, and a language module 306.

In certain embodiments, the audio detection module 302 detects, by use of a sensor (e.g., the input device 206, a microphone, an audio input device), an audio input. In some embodiments, the audio input includes instructions for spelling a word. The audio detection module 302 may detect the audio input, and may store the audio input for processing. In various embodiments, the audio input may be words spoken by a user that include the instructions for spelling the word. In one embodiment, the instructions for spelling the word may be instructions for spelling an uncommon word that is frequently misspelled. For example, the word may be “Cary” and the words spoken by the user may be “Where is Cary? That's C-A-R-Y.” As another example, the word may be “Cary” and the words spoken by the user may be “Where is Carrie? With two R′s and an I-E.”

In one embodiment, the audio conversion module 304 converts the audio input to text. In certain embodiments, the text includes the word. In some embodiments, the audio conversion module 304 may use a phonetic model to convert speech waveforms (e.g., sounds) into text (e.g., words). In various embodiments, the audio conversion module 304 may misspell certain words in the process of converting speech waveforms into text. In such embodiments, the context of such words by themselves may not facilitate correctly spelling the misspelled words. In some embodiments, the misspelled words may be names, places, etc. For example, the phrase “Where is Cary?” by itself may not facilitate a correct spelling of “Cary.” Accordingly, the text may include instructions for spelling the word.

In various embodiments, the language module 306 may spell a word based on a context of instructions within the text. In such embodiments, the instructions may include natural language terminology corresponding to the word. For example, the word may be “Cary,” and the instructions that corresponding to the word may be “That's C-A-R-Y.” As another example, the word may be “Carrie,” and the instructions corresponding to the word may be “With two R's and an I-E.” In certain embodiments, the word may be included within the instructions. For example, the word may be “bug” included within the instructions as “What's the latest B-U-G report.” As used herein, “natural language terminology” may refer to words that a person may use when speaking with another person, such as words used in a normal conversation with another person. For example, using natural language terminology the language module 306 may spell a word based on a context of speech that a person uses when speaking to another person.

In one embodiment, the language module 306 may spell the word based on a direct spelling of the word within the text. For example, the instructions may include a spelling of the entire word such as “That's C-A-R-Y” to spell the word “Cary.” In such instructions, natural language terminology includes the word “That's” to indicate that the user intends to clarify a word previously spoken.

In another embodiment, the language module 306 may spell the word based on a partial spelling of the word within the text. For example, the instructions may include a spelling of part of word such as “Where is Carrie? With two R's and an I-E,” to spell the word “Carrie.” In such instructions, natural language terminology includes the language “With two R's and an I-E” to indicate that the user intends to clarify a word previously spoken.

In a further embodiment, the language module 306 may spell the word based on a change to one or more letters of the word within the text. For example, the instructions may include a spelling of one or more letters of a word such as “Where is Cary? With a Y,” to spell the word “Cary.” In such instructions, natural language terminology includes the language “With a Y” to indicate that the user intends to clarify a word previously spoken.

In certain embodiments, the language module 306 may spell the word based at least one letter of the word using a phonetic alphabet within the text. For example, the instructions may include a spelling of at least one letter of a word using a word to represent a letter, such as “Tango” to represent the letter “T,” “Foxtrot” to represent the letter “F,” “Whiskey” to represent the letter “W,” and so forth. In such instructions, natural language terminology includes the language “Tango,” “Foxtrot,” and/or “Whiskey” to indicate that the user intends to spell at least a portion of a word. In some embodiments, the language module 306 may spell the word based on a spelling that includes an example of the letter, such as “A as in apple.” As used herein, a “phonetic alphabet” may be a spelling alphabet, a voice procedure alphabet, a radio alphabet, a telephone alphabet, or any set of words that are used to stand for letters of an alphabet in oral communication.

In various embodiments, the speech-to-text module 104 may determine that audio input includes instructions for spelling a word. In some embodiments, the speech-to-text module 104 may display a word in response to spelling the word based on a context of instructions within text that has been converted from speech. In one embodiment, the speech-to-text module 104 may not display instructions for spelling a word in response to determining that audio input includes the instructions. In other words, the speech-to-text module 104 may determine that the instructions are intended for spelling a word correctly, may spell the word correctly, and may display the word to a user without displaying the instructions.

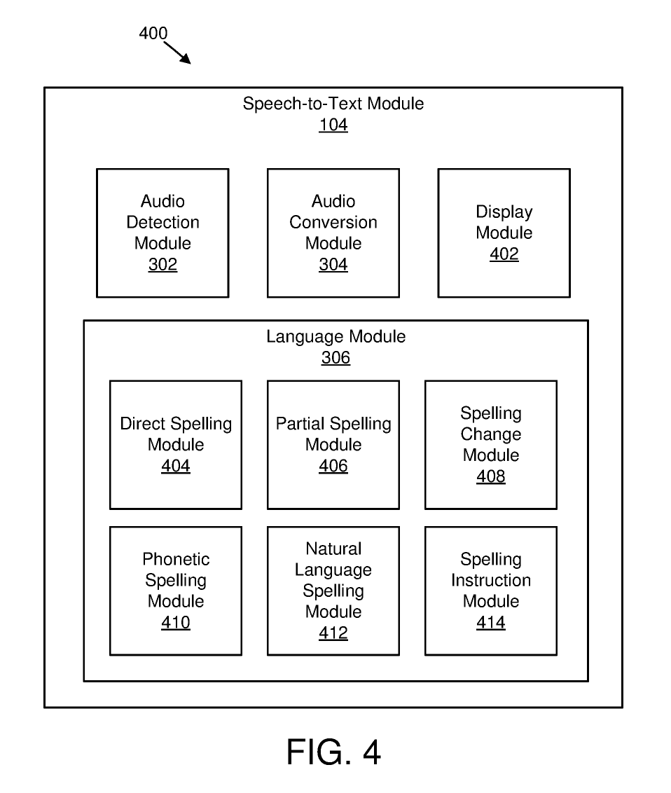

FIG. 4 is a schematic block diagram illustrating another embodiment of an apparatus 400 that includes one embodiment of the speech-to-text module 104. Furthermore, the speech-to-text module 104 includes one embodiment of the audio detection module 302, the audio conversion module 304, and the language module 306, that may be substantially similar to the audio detection module 302, the audio conversion module 304, and the language module 306 described in relation to FIG. 3. The speech-to-text module 104 also includes a display module 402, a direct spelling module 404, a partial spelling module 406, a spelling change module 408, a phonetic spelling module 410, a natural language spelling module 412, and a spelling instruction module 414.

In one embodiment, the display module 402 may display a correctly spelled word in response to spelling the word based on a context of instructions within a text that has been converted from an audio input. In some embodiments, the display module 402 may not display instructions for spelling a word in response to determining that audio input includes the instructions.

In certain embodiments, the direct spelling module 404 may spell a word based on a direct spelling of the word within the text. For example, the instructions may include a spelling of the entire word such as “That's C-A-R-Y” to spell the word “Cary.” In such instructions, natural language terminology includes the word “That's” to indicate that the user intends to clarify a word previously spoken.

In various embodiments, the partial spelling module 406 may spell a word based on a partial spelling of the word within the text. For example, the instructions may include a spelling of part of word such as “Where is Carrie? With two R's and an I-E,” to spell the word “Carrie.” In such instructions, natural language terminology includes the language “With two R's and an I-E” to indicate that the user intends to clarify a word previously spoken.

In some embodiments, the spelling change module 408 may spell a word based on a change to one or more letters of the word within the text. For example, the instructions may include a spelling of one or more letters of a word such as “Where is Cary? With a Y,” to spell the word “Cary.” In such instructions, natural language terminology includes the language “With a Y” to indicate that the user intends to clarify a word previously spoken.

In one embodiment, the phonetic spelling module 410 may spell a word based at least one letter of the word using a phonetic alphabet within the text. For example, the instructions may include a spelling of at least one letter of a word using a word to represent a letter, such as “Tango” to represent the letter “T,” “Foxtrot” to represent the letter “F,” “Whiskey” to represent the letter “W,” and so forth. In such instructions, natural language terminology includes the language “Tango,” “Foxtrot,” and/or “Whiskey” to indicate that the user intends to spell at least a portion of a word.

In certain embodiments, the natural language spelling module 412 may spell a word based on a context of speech that a person uses when speaking to another person within a text that has been converted from audio input. In various embodiments, the spelling instruction module 414 may determine that an audio input includes instructions for spelling a word by identifying natural language within text converted from the audio input.

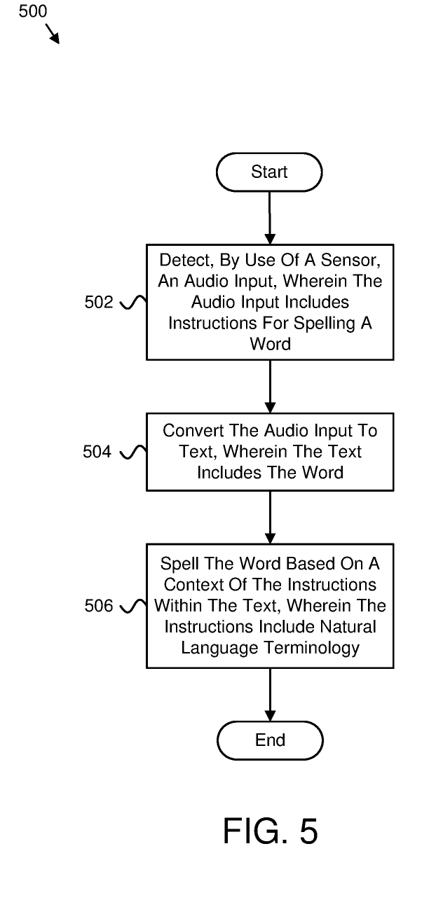

FIG. 5 is a schematic flow chart diagram illustrating an embodiment of a method 500 for spelling words. In some embodiments, the method 500 is performed by an apparatus, such as the information handling device 102. In other embodiments, the method 500 may be performed by a module, such as the speech-to-text module 104. In certain embodiments, the method 500 may be performed by a processor executing program code, for example, a microcontroller, a microprocessor, a CPU, a GPU, an auxiliary processing unit, a FPGA, or the like.

The method 500 may include detecting 502, by use of a sensor (e.g., the input device 206), an audio input. The audio input may include instructions for spelling a word. In certain embodiments, the audio detection module 302 may detect 502 the audio input. The method 500 may also include converting 504 the audio input to text. In various embodiments, the text includes the word. In some embodiments, the audio conversion module 304 may convert 504 the audio input to text.

The method 500 may include spelling 506 the word based on a context of the instructions within the text. In such embodiments, the instructions include natural language terminology. In certain embodiments, the language module 306 may spell 506 the word based on the context of the instructions within the text.

In some embodiments, spelling 506 the word based on the context of the instructions within the text includes spelling the word based on the context of a direct spelling of the word within the text. In various embodiments, spelling 506 the word based on the context of the instructions within the text includes spelling the word based on the context of a partial spelling of the word within the text. In one embodiment, spelling 506 the word based on the context of the instructions within the text includes spelling the word based on the context of a change to one or more letters of the word within the text.

In some embodiments, spelling 506 the word based on the context of the instructions within the text includes spelling the word based on the context of a spelling of at least one letter of the word using a phonetic alphabet within the text. In certain embodiments, spelling 506 the word based on the context of the instructions within the text includes spelling the word based on the context of speech that a person uses when speaking to another person within the text.

In various embodiments, the method 500 includes displaying the word in response to spelling the word based on the context of the instructions within the text. In certain embodiments, the method 500 includes determining that the audio input includes the instructions for spelling the word. In some embodiments, the method 500 includes not displaying the instructions in response to determining that the audio input includes the instructions.

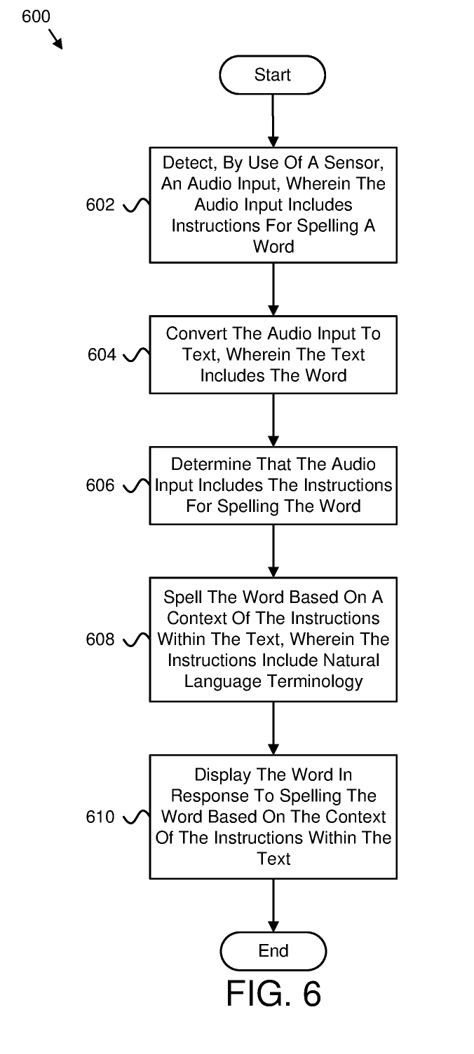

FIG. 6 is a schematic flow chart diagram illustrating another embodiment of a method 600 for spelling words. In some embodiments, the method 600 is performed by an apparatus, such as the information handling device 102. In other embodiments, the method 600 may be performed by a module, such as the speech-to-text module 104. In certain embodiments, the method 600 may be performed by a processor executing program code, for example, a microcontroller, a microprocessor, a CPU, a GPU, an auxiliary processing unit, a FPGA, or the like.

The method 600 may include detecting 602, by use of a sensor (e.g., the input device 206), an audio input. The audio input may include instructions for spelling a word. In certain embodiments, the audio detection module 302 may detect 602 the audio input. The method 600 may also include converting 604 the audio input to text. In various embodiments, the text includes the word. In some embodiments, the audio conversion module 304 may convert 604 the audio input to text.

The method 600 may also include determining 606 that the audio input includes the instructions for spelling the word. In some embodiments, the spelling instruction module 414 may determine 606 that the audio input includes the instructions for spelling the word.

The method 600 may include spelling 608 the word based on a context of the instructions within the text. In such embodiments, the instructions include natural language terminology. In certain embodiments, the language module 306 may spell 608 the word based on the context of the instructions within the text.

In some embodiments, spelling 608 the word based on the context of the instructions within the text includes spelling the word based on the context of a direct spelling of the word within the text. In various embodiments, spelling 608 the word based on the context of the instructions within the text includes spelling the word based on the context of a partial spelling of the word within the text. In one embodiment, spelling 608 the word based on the context of the instructions within the text includes spelling the word based on the context of a change to one or more letters of the word within the text.

In some embodiments, spelling 608 the word based on the context of the instructions within the text includes spelling the word based on the context of a spelling of at least one letter of the word using a phonetic alphabet within the text. In certain embodiments, spelling 608 the word based on the context of the instructions within the text includes spelling the word based on the context of speech that a person uses when speaking to another person within the text.

The method 600 may also include displaying 610 the word in response to spelling the word based on the context of the instructions within the text. In some embodiments, the display module 402 may display 610 the word in response to spelling the word based on the context of the instructions within the text.

In some embodiments, the method 600 includes not displaying the instructions in response to determining that the audio input includes the instructions.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a sensor;
a processor;
a memory that stores code executable by the processor to:
detect, by use of the sensor, an audio input, wherein the audio input comprises instructions for spelling a word;
convert the audio input to text, wherein the text comprises the word; and
spell the word based on a context of the instructions within the text, wherein the instructions comprise natural language terminology and a direct spelling of the word, and the code is configured to convert a phonetic alphabet into corresponding letters used for the direct spelling of the word.

2. (canceled)

3. (canceled)

4. The apparatus of claim 1, wherein the code executable by the processor spells the word based on the context of a change to one or more letters of the word within the text.

5. The apparatus of claim 1, wherein the code executable by the processor spells the word based on the context of a spelling of at least one letter of the word using a phonetic alphabet within the text.

6. A method comprising:
detecting, by use of a sensor, an audio input, wherein the audio input comprises instructions for spelling a word;
converting the audio input to text, wherein the text comprises the word; and
spelling the word based on a context of the instructions within the text, wherein the instructions comprise natural language terminology and a direct spelling of the word, and spelling the word comprises converting a phonetic alphabet into corresponding letters used for the direct spelling of the word.

7. (Canceled)

8. (canceled)

9. The method of claim 6, wherein spelling the word based on the context of the instructions within the text comprises spelling the word based on the context of a change to one or more letters of the word within the text.

10. The method of claim 6, wherein spelling the word based on the context of the instructions within the text comprises spelling the word based on the context of a spelling of at least one letter of the word using a phonetic alphabet within the text.

11. The method of claim 6, wherein spelling the word based on the context of the instructions within the text comprises spelling the word based on the context of speech that a person uses when speaking to another person within the text.

12. The method of claim 6, further comprising displaying the word in response to spelling the word based on the context of the instructions within the text.

13. The method of claim 6, further comprising determining that the audio input comprises the instructions for spelling the word.

14. The method of claim 13, further comprising not displaying the instructions in response to determining that the audio input comprises the instructions.

15. A program product comprising a non-transitory computer readable storage medium that stores code executable by a processor, the executable code comprising code to perform:
detecting, by use of a sensor, an audio input, wherein the audio input comprises instructions for spelling a word;
converting the audio input to text, wherein the text comprises the word; and
spelling the word based on a context of the instructions within the text, wherein the instructions comprise natural language terminology and a direct spelling of the word, and spelling the word comprises converting a phonetic alphabet into corresponding letters used for the direct spelling of the word.

16. The program product of claim 15, wherein the executable code further comprises code to perform spelling the word based on the context of speech that a person uses when speaking to another person within the text.

17. The program product of claim 15, wherein the executable code further comprises code to perform spelling the word based on the context of a change to one or more letters of the word within the text.

18. The program product of claim 15, wherein the executable code further comprises code to perform displaying the word in response to spelling the word based on the context of the instructions within the text.

19. The program product of claim 15, wherein the executable code further comprises code to perform determining that the audio input comprises the instructions for spelling the word.

20. The program product of claim 19, wherein the executable code further comprises code to perform not displaying the instructions in response to determining that the audio input comprises the instructions.
